(19) United States
(12) Patent Application Publication
(10) Pub. No.: US 2010/0066554 A1
(43) Pub. Date: Mar. 18, 2010

(54) HOME APPLIANCE SYSTEM

(75) Inventors: Phal Jin LEE, Changwon-si (KR); Hoi Jin JEONG, Changwon-si (KR); Jong Hye HAN, Changwon-si (KR); Young Soo KIM, Changwon-si (KR); In Haeng CHO, Changwon-si (KR); Si Moon JEON, Changwon-si (KR)

Correspondence Address: KED & ASSOCIATES, LLP, P.O. Box 221200, Chantilly, VA, 20153-1200, US

(73) Assignee: LG Electronics Inc.

(21) Appl. No.: 12/551,827

(22) Filed: Sep. 1, 2009

Related U.S. Application Data
(60) Provisional application No. 61/093,551, filed on Sep. 2, 2008.

(51) Int. Cl. G08B 21/00; G10L 13/00; G10L 21/00

(52) U.S. Cl. 340/679; 704/270; 704/E13.001; 704/276; 704/E21.001

(57) ABSTRACT

A home appliance system includes a home appliance outputting product information as a sound and a mobile terminal confirming the product information based on the sound. The mobile terminal can receive the sound, convert the sound into the product information and output the product information to an external user and a repairman.

### BACKGROUND OF THE INVENTION

1. Field of the Invention

The present invention relates to a home appliance system including a home appliance, and more particularly, to a home appliance system which allows a user to control on/off of an output unit and control the order of output audio signals.

2. Discussion of the Related Art

In a conventional home appliance system, a user personally transmits information on a trouble of the home appliance system to a repairman to repair the home appliance system, in general. Furthermore, when the user informs the repairman of the information on the trouble, the user transmits the information on the trouble to an administration system by using a signal sound. However, the conventional home appliance system has a problem that the user cannot select an on or off state of an output unit. Furthermore, the user cannot select transmission of the signal sound, and thus the information is transmitted without removing elements which obstruct the transmission of the signal sound. Accordingly, the conventional home appliance system and home appliances cannot efficiently transmit the signal sound.

Moreover, the conventional home appliance system cannot recognize the start and end of an output audio signal, and thus the conventional home appliance system cannot correctly transmit product information.

### SUMMARY OF THE INVENTION

It is an object of the present invention to provide a home appliance system which controls a signal sound output from an output unit through an operating unit and allows a user to recognize the order of output audio signals so as to correctly output product information.

According to an aspect of the present invention, there is provided a home appliance system which includes a home appliance receiving an external on/off command signal, converting product information into at least one audio signal and outputting a signal sound corresponding to the at least one audio signal; and a mobile terminal receiving the signal sound, inversely converting the signal sound into the product information based on the signal sound and outputting the product information such that an external user recognizes the product information.

According to the home appliance system of the present invention, the user can remove an output signal sound through the operating unit. Accordingly, the home appliance removes elements which obstruct the signal sound and then correctly outputs the signal sound. Furthermore, the home appliance system according to the present invention can allow the user to easily check the state of the home appliance through the mobile terminal.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a washing machine system according to an embodiment of the present invention;

FIG. 2 is a block diagram for showing a control flow of the washing machine system illustrated in FIG. 1;

FIG. 3 illustrates discrimination among a plurality of audio signals S1, S2 and S3 output from a conversion unit illustrated in FIG. 2 according to an embodiment of the present invention; and

FIG. 4 illustrates discrimination among the plurality of audio signals S1, S2 and S3 illustrated in FIG. 3 according to another embodiment of the present invention.

### DETAILED DESCRIPTION OF THE PREFERRED EMBODIMENTS

Hereinafter, an embodiment of the present invention will be described below with reference to the accompanying drawings.

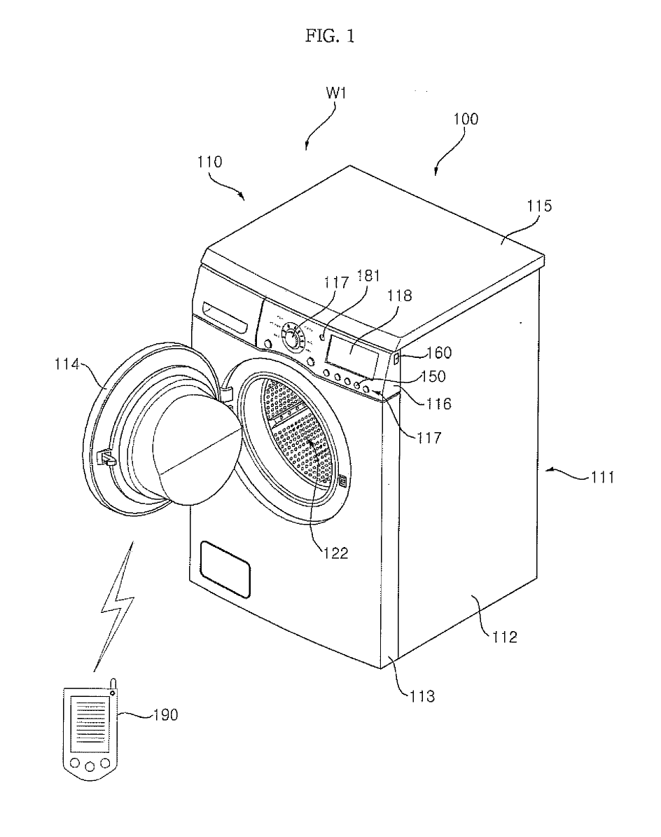

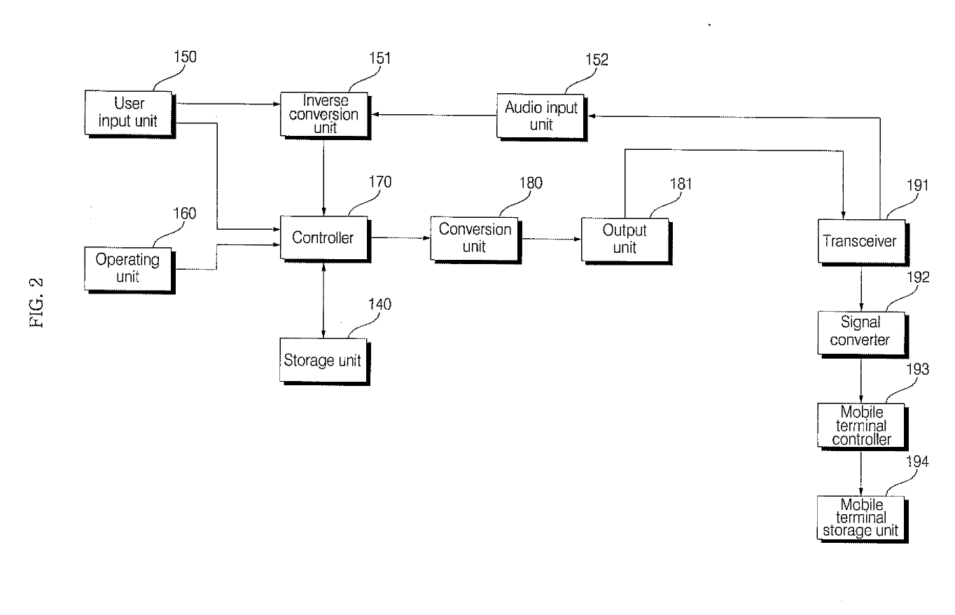

FIG. 1 is a perspective view of a washing machine system W1 as an example of a home appliance system according to an embodiment of the present invention. FIG. 2 is a block diagram for showing a control flow of the washing machine system W1 illustrated in FIG. 1. The present invention is not limited to the washing machine system W1 and can be applied to any home appliance system. However, the present invention will be explained based on the washing machine system W1 in the following description for convenience of explanation.

Referring to FIGS. 1 and 2, the washing machine system W1 includes a washing machine 100 receiving an external on/off command signal, converting product information into at least one audio signal and outputting a signal sound corresponding to the audio signal, and a mobile terminal 190 receiving the signal sound, inversely converting the signal sound into the product information and outputting the product information such that a user recognizes the product information.

The washing machine 100 includes a cabinet 111, a tub 122 which is located inside the cabinet 111 and washes the laundry, a motor (not shown) driving the tub 122, a water supply (not shown) supplying water for washing the laundry to the tub 122, and a drainage unit (not shown) discharging the water after washing. The cabinet 111 includes a cabinet body 112, a cabinet cover 113 arranged on the cabinet body 112 and combined with the cabinet body 112, a control panel 116 arranged on the cabinet cover to control the operation of the washing machine 110, and a top plate 115 located on the control panel 116 and combined with the cabinet body 112. The cabinet cover 113 includes a hole (not shown) through which the laundry is put in and taken out of the washing machine 100 and a door 114 turned to open and close the hole.

The mobile terminal 190 includes a transceiver 191 transmitting/receiving the signal sound output from an output unit 181 of the washing machine 100, a signal converter 192 inversely converting the signal sound received from the transceiver 191 into the product information, a mobile terminal controller 193 reading the product information, and a mobile terminal storage unit 194 storing the product information read by the mobile terminal controller 193.

The washing machine 100 includes an operating unit 150 receiving an external on/off command signal, a conversion unit 180 converting product information into at least one audio signal, the output unit 181 which is turned on/off according to the external on/off command signal when the external on/off command signal is received from the operating unit 150 and outputs a signal sound corresponding to the at least on audio signal output from the conversion unit 180, an input unit 150 receiving an external operation command signal, and a controller 170 controlling the at least one audio signal output from the conversion unit 180 such that a user recognizes output of the signal sound.

When the washing machine 100 is operated, product information of the washing machine 100 is generated. The product information is transmitted to the controller 170. The product information is composed of unit signals. Furthermore, the product information includes at least one of operation information and trouble information of the washing machine 100. The operation information includes information required to operate the washing machine 100, such as information on a washing operation, information on a spin-drying operation and information on a rinsing operation. The trouble information includes information on a trouble of the washing machine 100, which is generated when the washing machine 100 is operated and information on a mechanical trouble of the washing machine 100.

The controller 170 transmits the product information to the conversion unit 180. The conversion unit 180 converts the product information into at least one audio signal and outputs the at least one audio signal to the output unit 181. When the external on command signal is input through the operating unit 150, the output unit 181 receives the at least one audio signal and outputs the signal sound corresponding to the audio signal.

The user can control the output unit 181 through the operating unit 150. When the user inputs the external on command signal to the operating unit 150, the output unit 181 operates. When the user inputs the external off command signal to the operating unit 150, the operation of the output unit 181 is stopped. Accordingly, the user can control the signal sound output from the output unit 181 through the operating unit 150 according to external environment. That is, when an external video system or other home appliances generate external noise, the user inputs the external off command signal to the operating unit 150 to control output of the signal sound. When the user determines that the external noise decreases, the user can control the output signal 181 to output the signal sound through the operating unit 150. The output unit 181 can be a speaker, a buzzer output unit, etc. and can include any means capable of outputting the signal sound.

The signal sound output from the output unit 181 is transmitted to the mobile terminal 190. The mobile terminal 190 inversely converts the signal sound into the product information and outputs the product information such that the user can recognize the product information. A control flow of the mobile terminal 190 is explained.

When the audio signal is output from the conversion unit 180 of the washing machine 100, the output unit 181 outputs the signal sound corresponding to the audio signal. The signal sound is transmitted to the mobile terminal 190. The transmitted signal sound is received by the transceiver 191. The transceiver 191 can not only receive the signal sound but also output a signal sound generated in the mobile terminal 190. The received signal sound is transmitted to the signal converter 192. The signal sound is converted into an audio signal and transmitted in the above-described transmitting operation. The transmitted audio signal is converted into the product information by the signal converter 192. The transmitted audio signal is converted into the product information through a process opposite to the aforementioned process of converting the product information into the audio signal. The product information is transmitted to the mobile terminal controller 193. The mobile terminal controller 193 stores predetermined data, and thus the mobile terminal controller 193 compares the product information to the predetermined data. When the product information is different from the predetermined data, the mobile terminal controller 193 outputs the product information such that the user recognizes the product information. Furthermore, the mobile terminal controller 193 stores the product information in the mobile terminal storage unit 194. Accordingly, the user can store trouble history or operation information of the washing machine 100.

The mobile terminal controller 193 not only compares the product information to the predetermined data but also determines whether the product information is correctly transmitted. The product information may be damaged by external obstructing elements while being transmitted to the mobile terminal controller 193. When the mobile terminal controller 193 determines that the product information is damaged, the mobile terminal controller 193 transmits an external command signal representing that the product information is damaged to the signal converter 192. The transmitted external command signal is converted into an audio signal corresponding thereto by the signal converter 192. The audio signal corresponding to the external command signal is transmitted to the transceiver 191. The transceiver 191 outputs a signal sound corresponding to the audio signal and the signal sound is transmitted to the washing machine 100. The signal sound is transmitted to an audio input unit 152, converted into the external command signal through an inverse converter 151 and transmitted to the controller 170. The controller 170 re-transmits the product information to the conversion unit 180 when the external command signal is received. The re-transmitted product information is output through the output unit 181 through a process opposite to the aforementioned process. Accordingly, the washing machine system W1 can receive the external command signal and repeatedly transmit the correct product information even when damaged product information is transmitted to the mobile terminal 190. Furthermore, the washing machine system W1 can send the correct product information such that the washing machine 100 can be correctly repaired.

The user can input an external operation command signal through the operating unit 160. When the user inputs the external operation command signal, the controller 170 controls the at least one audio signal which is converted by the conversion unit 180 and output such that the user recognizes output of the signal sound. The at least one audio signal will be explained in detail.

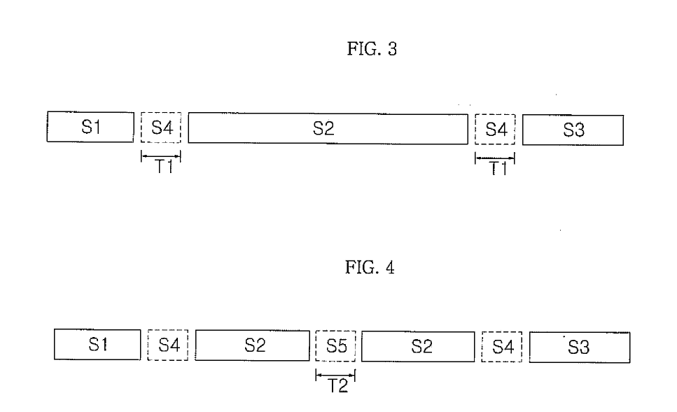

FIG. 3 illustrates discrimination among a plurality of audio signals S1, S2 and S3 output from the conversion unit 180 illustrated in FIG. 2 according to an embodiment of the present invention.

Referring to FIGS. 1, 2 and 3, the at least one audio signal may include the plurality of audio signals S1, S2 and S3. The plurality of audio signals S1, S2 and S3 include the first audio signal S1 output from the conversion unit 180 to allow the user to recognize output of the product information, the second audio signal S2 converted from the product information and output when the first audio signal S1 is ended, and the third audio signal S3 converted by the conversion unit 180 and output to allow the user to recognize output of the product information through the output unit 181 after the second audio signal S2 is converted and output.

That is, when the washing machine 100 is operated and the user inputs an external command signal, the controller 170 transmits the product information to the conversion unit 180. Then, the conversion unit 180 converts the product information into the second audio signal S2. When the conversion unit 180 finishes conversion of the product information into the second audio signal S2, the conversion unit 180 transmits the first audio signal S1 to the user through the output unit 181. The transmitted first audio signal S1 is output through the output unit 181. A signal sound corresponding to the first audio signal S1 makes the user recognize that the second audio signal S2 will be output. When output of the signal sound corresponding to the first audio signal S1 is completed, the conversion unit 180 transmits the second audio signal S2 to the output unit 181. Then, the controller 170 controls the output unit 181 to output a signal sound corresponding to the second audio signal S2. When the signal sound corresponding to the second audio signal S2 has been output, the controller 170 controls the conversion unit 180 to output the third audio signal S3 to the output unit 181. A signal sound corresponding to the third audio signal S3 makes the user recognize that the second audio signal S2 has been output.

The signal sound corresponding to the first audio signal S1 and the signal sound corresponding to the third audio signal S3 include at least one of a voice, melody and buzzer sound which are recognizable by the user. The user can prepare transmission of the second audio signal S2 corresponding to the product information when the signal sound corresponding to the first audio signal S1 is output from the output unit 181. Furthermore, the user can recognize that the second audio signal S2 corresponding to the product information has been transmitted when the signal sound corresponding to the third audio signal S2 is output from the output unit 181. Accordingly, the user can correctly recognize transmission of the product information, and thus user's convenience is improved. Furthermore, elements interfering with the signal sound corresponding to the second audio signal S2 can be removed and output of the second audio signal S2 can be prepared when the second audio signal S2 is output, and thus the product information can be effectively output.

The conversion unit 180 can output a discrimination signal S4 for discriminating among the first, second and third audio signals S1, S2 and S3 for a dummy time T1. Specifically, after the conversion unit 180 outputs the first audio signal S1, the conversion unit 180 outputs the discrimination signal S4 for the dummy time T1. After the discrimination signal S4 is output, the conversion unit 180 outputs the second audio signal S2. After the second audio signal S2 is output, the conversion unit 180 outputs the discrimination signal S4 again for the dummy time T1. After the discrimination signal S4 is output, the conversion unit 180 outputs the third audio signal S3. Accordingly, the user can prepare output of the second audio signal S2 corresponding to the product information for the dummy time T1. The second audio signal S2 can be correctly output, and thus the product information can be prevented from being damaged.

The controller 170 can control the output unit 181 to output no sound as a signal sound corresponding to the discrimination signal S4 when the discrimination signal S4 is input to the output unit 181.

The mobile terminal controller 190 can recognize the order of the first, second and third audio signals S1, S2 and S3. Furthermore, the mobile terminal controller 190 determines whether the second audio signal S2 is damaged. When the mobile terminal controller 190 determines that the first, second and third audio signals S1, S2 and S3 are input in the order different from the previous input order, the mobile terminal controller 190 outputs an external command signal through the transceiver 191. The external command signal is transmitted to the inverse conversion unit 151 through the audio input unit 152. The external command signal is converted into external information by the inverse conversion unit 151 and transmitted to the controller 170. The controller 170 controls the conversion unit 180 to re-output the plurality of audio signals S1, S2 and S3 based on the external information. The user can re-transmit the plurality of audio signals S1, S2 and S3 according to the external command signal even if the plurality of audio signals S1, S2 and S3 generated in the washing machine 100 are damaged and transmitted to the mobile terminal 190. Accordingly, the correct product information can be transmitted.

The mobile terminal controller 193 determines whether the second audio signal S2 is damaged. When the mobile terminal controller 193 determines that the second audio signal S2 is damaged, the mobile terminal controller 193 outputs the external command signal as described above or in a manner similar to the aforementioned manner. The external command signal is input to the audio input unit 152 and transmitted to the controller 170. The controller 170 controls the conversion unit 180 to re-output the second audio signal S2 according to the external command signal. The mobile terminal 190 can receive the second audio signal S2 through the re-output of the second audio signal S2 even when the second audio signal S2 is damaged and transmitted. Accordingly, the correct product information is transmitted to the mobile terminal 190, and thus the washing machine 100 can be easily administrated. Furthermore, since the second audio signal S2 is re-transmitted through the external command signal even though the user cannot determine whether the second audio signal S2 is damaged, user's convenience is improved.

FIG. 4 illustrates discrimination among the plurality of audio signals S1, S2 and S3 illustrated in FIG. 3 according to another embodiment of the present invention. Referring to FIGS. 1, 2 and 4, the controller 170 controls the conversion unit 180 to output the first audio signal S1 when the external command signal is input from the input unit 160. After the first audio signal S1 is output, the conversion unit 180 converts the product information into the second audio signal S2 and outputs the second audio signal S2. The second audio signal S2 is repeatedly output. That is, the conversion unit 180 outputs the second audio signal S2 after the first audio signal S1 is output. Furthermore, after the second output signal S2 is output, the conversion unit 180 re-outputs the second audio signal S2. Accordingly, the correct product information can be output according to the re-transmitted second audio signals S2 when the second audio signal S2 is damaged by external obstructing elements.

The conversion unit 180 outputs a data discrimination signal S5 for discriminating the repeatedly output second audio signals S2 from each other for a data dummy time T2. Specifically, the conversion unit 180 outputs the second audio signal S2 and then outputs the data discrimination signal S5 for the data dummy time T2. Then, the conversion unit 180 outputs the second audio signal S2 again. Since the data discrimination signal S5 is output for the data dummy time T2, the second audio signals S2 can be easily discriminated from each other when the second audio signals S2 are output.

The controller 170 can control the output unit 181 to output no sound as a signal sound corresponding to the data discrimination signal S5 when the data discrimination signal S5 is input to the output unit 181.

What is claimed is:

1. A home appliance system comprising:
a home appliance receiving an external on/off command signal, converting product information into at least one audio signal and outputting a signal sound corresponding to the at least one audio signal; and
a mobile terminal receiving the signal sound, inversely converting the signal sound into the product information based on the signal sound and outputting the product information such that an external user recognizes the product information.

2. The home appliance system of claim 1, wherein the home appliance comprises:
an operating unit receiving the external on/off command signal;
a conversion unit converting the product information of the home appliance into the at least one audio signal and outputting the at least one audio signal;
an output unit which is turned on/off according to the external on/off command signal when the external on/off command signal is input from the operating unit and outputs a signal sound corresponding to the at least one audio signal output from the conversion unit; and
a controller controlling the at least one audio signal converted by the conversion unit and output to allow a user to recognize output of the signal sound.

3. The home appliance system of claim 2, wherein the at least one audio signal includes a plurality of audio signals which include a first audio signal output from the conversion unit to allow the user to recognize output of the product information and a second audio signal converted from the product information and output after the first audio signal is output.

4. The home appliance system of claim 3, wherein the controller controls the conversion unit to convert and output a third audio signal such that the user recognizes output of the produce information to the output unit after the second audio signal is output.

5. The home appliance system of claim 4, wherein a signal sound corresponding to the first audio signal and a signal sound corresponding to the third audio signal include at least one of a voice, melody and buzzer sound which are recognizable by the user.

6. The home appliance system of claim 4, wherein the controller controls the conversion unit to output a discrimination signal for discriminating among the first, second and third audio signals for a dummy time between the neighboring audio signals.

7. The home appliance system of claim 6, wherein the controller controls the output unit to output no sound as a signal sound corresponding to the discrimination signal when the discrimination signal is input to the output unit.

8. The home appliance system of claim 3, wherein the controller controls the conversion unit to repeatedly output the second audio signal after the conversion unit outputs the first audio signal.

9. The home appliance system of claim 8, wherein the controller controls the conversion unit to output a data discrimination signal for a data dummy time between the repeatedly output second audio signals.

10. The home appliance system of claim 9, wherein the controller controls the output units to output no sound as a signal sound corresponding to the data discrimination signal when the data discrimination signal is input.

11. The home appliance system of claim 1, wherein the product information includes at least one of operation information and trouble information of the home appliance.

12. The home appliance system of claim 2, further comprising an input unit receiving an external operation command signal, the controller controls the outputting order of the at least one audio signal when the user inputs the external operation command signal through the input unit.

13. The home appliance system of claim 1, wherein the mobile terminal compares the signal sound to previously input data to confirm the product information, determines whether the home appliance has a trouble based on the product information and outputs the product information to a repairman

14. The home appliance system of claim 1, wherein the mobile terminal comprises:
a transceiver transmitting/receiving an audio signal corresponding to the signal sound;
a signal converter inversely converting the audio signal received from the transceiver into the product information; and
a mobile terminal controller reading the product information.

15. The home appliance system of claim 14, wherein the mobile terminal further comprises a mobile terminal output unit outputting the read product information such that the user recognizes the product information.

16. The home appliance system of claim 15, wherein the output unit comprises a display displaying the read product information as an image.

17. The home appliance system of claim 15, wherein the output unit comprises a voice output unit outputting a voice to allow the user recognize the product information.
